(19) United States
(12) Patent Application Publication
(10) Pub. No.: US 2005/0123810 A1
(43) Pub. Date: Jun. 9, 2005

(54) System and method for co-production of hydrogen and electrical energy

(76) Inventor: Chellappa Balan, Niskayuna, NY (US)

Correspondence Address: Patrick S. Yoder;FLETCHER YODER, P.O. Box 692289, Houston, TX, 77269-2289, US

(21) Appl. No.: 10/731,373

(22) Filed: Dec. 9, 2003

(51) Int. Cl. H01M 8/06; H01M 8/12

(52) U.S. Cl. 429/19; 429/34; 429/32; 429/13

(57) ABSTRACT

A system and method for co-production of hydrogen and electrical energy. The system comprises a fuel cell assembly comprising a plurality of fuel cells. The fuel cells further comprise a cathode inlet for receiving a compressed oxidant, an anode inlet for receiving a fuel feed stream, an anode outlet in fluid communication with an anode exhaust stream and a cathode outlet in fluid communication with a cathode exhaust stream. At least a portion of the fuel feed stream reacts with the oxidant to produce electrical power. The anode exhaust stream comprises hydrogen. The co-production system further comprises a separation unit in fluid communication with the fuel cell assembly. The separation unit is configured to receive the anode exhaust stream from the fuel cell assembly to separate hydrogen from the anode exhaust stream.

### BACKGROUND OF THE INVENTION

The present invention relates to hydrogen-based energy generation systems and more particularly to co-production of hydrogen and electrical energy utilizing integrated power generation systems.

In certain hydrogen-based energy generation systems, fuel cells have been integrated with conventional gas turbines for increased power generation capacity in electrical power plants. Known fuel cells, such as, for example, solid oxide fuel cells include a plurality of solid oxide fuel cells that react a gaseous fuel, such as reformed natural gas, with air to produce electrical power and a hot gas. A compressor supplies the air for the fuel cells, which operate at elevated pressure, and produce hot gas for expansion in the turbine. Fuel cell exhaust air is combined with fuel cell exhaust fuel and the resulting heat release is converted to work in the turbine portion of the plant. Thus, electrical energy is produced by both the solid oxide fuel cell generator and the turbine.

Solid-oxide fuel cells usually do not consume all of the fuel that is fed into the inlet of the fuel cells. The composition of the spent fuel stream from the fuel cells primarily includes carbon monoxide (CO), carbon dioxide (CO₂), hydrogen (H₂), methane (CH₄) and water (H₂O) along with the equilibrium species. Typically, the spent fuel stream is combusted in a burner in presence of air to recover the fuel content before releasing it to the atmosphere.

In such systems, hydrogen is a beneficial co-product for its uses in a hydrogen-based economy. Hydrogen is used, for example as a fuel, a chemical feedstock and many other purposes. Hydrogen is also useful in fertilizer and petrochemical industries, and in the production of metal hydrides, which are sources of fuel. Existing co-production plants generating electricity and hydrogen focus on producing hydrogen from a portion of the fuel inlet used for the fuel cells through external reforming, which is energy and capital intensive.

Accordingly, there is a need for a co-production plant that can co-produce hydrogen and electrical energy using the spent gases from the fuel cells.

### BRIEF DESCRIPTION OF THE INVENTION

Briefly, in accordance with some aspects of the present technique, systems for co-production of hydrogen and electrical energy are disclosed herein. The co-production systems comprise a fuel cell assembly comprising a plurality of fuel cells. The fuel cells further comprise a cathode inlet for receiving a compressed oxidant, an anode inlet for receiving a fuel feed stream, an anode outlet in fluid communication with an anode exhaust stream and a cathode outlet in fluid communication with a cathode exhaust stream. At least a portion of the fuel feed stream reacts with the oxidant to produce electrical power. The anode exhaust stream comprises hydrogen. The co-production systems further comprise a separation unit in fluid communication with the fuel cell assembly. The separation unit is configured to receive the anode exhaust stream from the fuel cell assembly to separate hydrogen from the anode exhaust stream.

In accordance with some other aspects of the present technique, system for co-production of hydrogen and electrical energy are disclosed herein. The co-production systems comprise a fuel cell assembly comprising a plurality of fuel cells. The fuel cells further comprise a cathode inlet for receiving a compressed oxidant, an anode inlet for receiving a fuel feed stream, an anode outlet in fluid communication with an anode exhaust stream and a cathode outlet in fluid communication with a cathode exhaust stream. At least a portion of the fuel feed stream reacts with the oxidant to produce electrical power. The fuel cell assembly is operated at a low utilization mode, in which the fuel feed stream is consumed at a rate less than or equal to 70%. The anode exhaust stream comprises hydrogen. The co-production systems further comprise a separation unit in fluid communication with the fuel cell assembly. The separation unit is configured to receive the anode exhaust stream from the fuel cell assembly to separate hydrogen from the anode exhaust stream.

In yet another aspect in accordance with the present technique, a method for co-production of hydrogen and electrical energy is disclosed.

### BRIEF DESCRIPTION OF THE DRAWINGS

The foregoing and other advantages and features of the invention will become apparent upon reading the following detailed description and upon reference to the drawings in which:

FIG. 1 is a schematic diagram of an exemplary co-production system of hydrogen and electrical energy in accordance with the present technique;

FIG. 2 is a schematic diagram of a second embodiment of the co-production system of hydrogen and electrical energy in accordance with the present technique;

FIG. 3 is a schematic diagram of a third embodiment of the co-production system of hydrogen and electrical energy in accordance with the present technique;

FIG. 4 is a schematic diagram of a fourth embodiment of the co-production system of hydrogen and electrical energy in accordance with the present technique;

FIG. 5 is a schematic diagram of a fifth embodiment of the co-production system of hydrogen and electrical energy in accordance with the present technique;

FIG. 6 is a schematic diagram of a sixth embodiment of the co-production system of hydrogen and electrical energy in accordance with the present technique;

FIG. 7 is a graph showing the fuel cell exit composition of H₂ and CO as a function of the % fuel utilization in the fuel cell;

FIG. 8 is a graph showing the fuel cell exit potentials as a function of % fuel utilization in the fuel cell.

### DETAILED DESCRIPTION OF SPECIFIC EMBODIMENTS

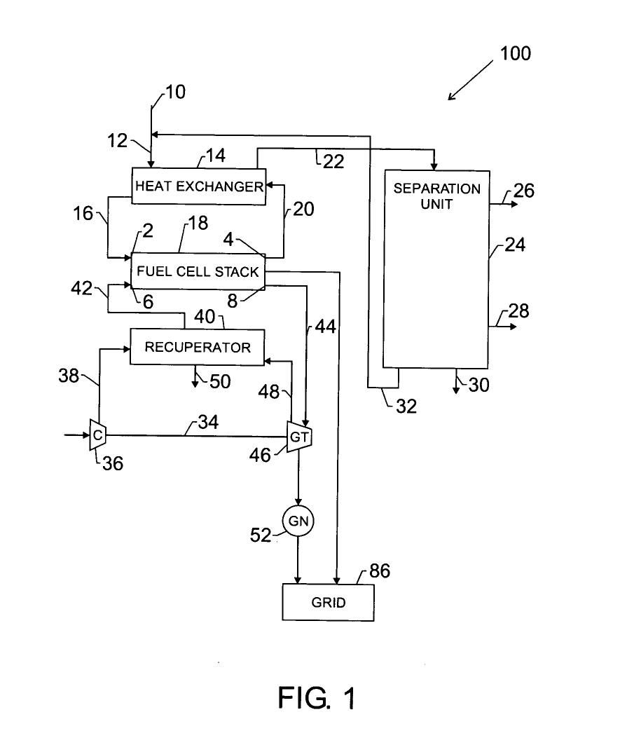

FIG. 1 schematically illustrates an exemplary co-production system 100 including an integrated gas turbine and fuel cell hybrid power generator. The co-production system 100 has a fuel cell portion co-producing electricity and hydrogen and a turbine portion producing electricity in tandem with one another. The turbine portion includes an oxidant compressor 36, a turbine 46, a rotor 34, by which the turbine 46 drives compressor 36, an electrical generator 52, and a recuperator 40. The fuel cell portion includes a fuel cell assembly 18, a heat exchanger 14, and a separation unit 24. As explained in some detail below, while the basic components of the fuel cell portion and the turbine portion are well known, efficient co-production of hydrogen from the fuel cell portion enhances the overall utility of the co-production systems. Strategic interconnection of the plant components with re-circulation flow paths also enhances the performance and efficiency of the co-production systems disclosed herein. In various embodiments of the co-production system described herein, the oxidant is ambient air. It should be understood, however that any other oxidant stream comprising the required amount of oxygen for the reaction in the fuel cell may be used for the same purpose.

In operation, an exemplary compressor 36 has at least one stage, and compressor 36 inducts ambient air and produces a compressed air stream 38. The compressed air stream 38 is fed into the recuperator 40, which is a known type of heat exchanger including isolated flow paths. Compressed air stream enters recuperator 40 in one recuperator flow path, and a turbine exhaust stream 48 is passed into recuperator 40 in another recuperator flow path, whereby heat from the turbine exhaust 48 is transferred to the compressed air stream 38 without mixing of compressed air stream 38 and turbine exhaust stream 48. Compressed air stream 38 is therefore heated within recuperator 40 by turbine exhaust stream 48, and a heated compressed air stream 42 exits recuperator 40 and flows to a cathode inlet 6 of the fuel cell assembly 18 where it serves as an oxidant. By heating compressed air stream 38 with turbine exhaust 48, the costs of conventional heaters and/or regenerative heat exchangers to raise a temperature of the fuel cell oxidant are avoided, and turbine exhaust stream 48 is cooled before being discharged into the atmosphere.

Fuel cell assembly 18 comprises a plurality of the fuel cells (not shown). Fuel cells are energy conversion devices that produce electricity by electrochemically combining a fuel and an oxidant, such as air, across an ion conduction layer. More particularly, each fuel cell includes an anode, an electrolyte, and a cathode (not shown) arranged for example in a tubular or planer configuration. In a fuel cell, hydrogen is used as the primary the fuel and the hydrogen, and oxygen from an oxidant stream react to produce water and electricity. Electrochemical conversion of carbon monoxide (CO) to carbon dioxide (CO₂) is another mechanism that also produces electricity. In an exemplary embodiment, fuel cell assembly 18 comprises a plurality of solid oxide fuel cell (SOFC) units with an oxygen-ion conducting solid electrolyte, such as yttria stabilized zirconia (YSZ), ceria-doped zirconia, or lanthanum strontium gallium manganate. In alternative embodiments, fuel cell assembly 18 may include, for example, molten carbonate electrolytes or other known electrolyte materials suitable for use. In various embodiments of the co-production system described herein, the fuel cell is selected from the group consisting of solid oxide fuel cells, protonic ceramic fuel calls, regenerative fuel cells and molten carbonate fuel cells. In various embodiments, the fuel cells in the fuel cell assembly 18 may have a planer or a tubular configuration.

Air inlet 6 and air outlet 8 in the fuel cell assembly 18 are referred to herein as a cathode inlet and a cathode outlet, respectively, as they provide oxidant airflow for the cathodes of fuel cell assembly 18. Similarly fuel inlet 2 and fuel outlet 4 in the fuel cell assembly 18 are referred to herein as an anode inlet and an anode outlet, respectively, as they provide fuel flow for the anodes of fuel cell assembly 18.

The heated compressed air stream 42 from the recuperator 40 enters the fuel cell assembly 18 through cathode inlet 6 and flows through the fuel cell units in the fuel cell assembly 18. At least a portion of the fuel reacts electrochemically with the oxidant air flowing through the fuel cell assembly to produce electricity. Spent air 44 is exhausted from fuel assembly 18 through cathode outlet 8, referred to herein as the cathode exhaust stream.

Gaseous fuel 10, which in different embodiments may be natural gas, methane or a coal derived fuel gas is fed into heat exchanger 14, which is a known type of heat exchanger including isolated flow paths. In an exemplary embodiment, the fuel stream 10 may be driven by fuel pump (not shown) through a de-sulfurizer (not shown), which may include a vessel containing a bed of sulfur sorbent through which fuel flows. Heat from fuel cell anode exhaust stream 20 is transferred to the incoming fuel stream 12 to warm the fuel therein before being fed into the fuel cell assembly 18. Complexity and expense of an external heater for the fuel cell assembly is therefore avoided, and anode exhaust stream 20 is cooled to facilitate co-production of hydrogen from the anode exhaust stream 20.

Hydrogen is needed for the electrochemical reaction in the fuel cell assembly 18 to produce water and electricity. Typically, hydrogen is produced by reforming a hydrocarbon fuel along with steam. This process is energy intensive and significant heat is absorbed in the overall reforming process. The main constituent of natural gas is methane (CH₄), which reacts with steam in a two-step reaction to produce hydrogen. In accordance with the present technique as shown in FIG. 1, the fuel cell assembly 18 utilizes internal reforming to convert the incoming fuel 12 to produce hydrogen. Through the internal reforming of incoming fuel 12, for example, natural gas is converted to hydrogen following the reactions (1) and (2) as mentioned below.
CH₄+H₂O [symbol] CO+3H₂ (1)
CO+H₂O [symbol] C₂+H₂ (2)

At least a portion of the incoming fuel 12 is converted to generate hydrogen by internal reforming within the fuel cells of the fuel cell assembly 18. In the internal reforming process in the fuel cells, reforming takes place across the anode, which may contain a suitable steam reforming catalyst, such as nickel. In some embodiments, steam may be introduced to the fuel stream 12 to initiate and facilitate reforming. The water produced by the electrochemical reaction in the fuel cells is used for the internal reforming process in the fuel cell assembly 18. Once expended in the fuel cells, spent fuel 20, as part of the anode exhaust stream, is exhausted from fuel cell assembly 18 through anode outlet 4. The fuel cells typically do not convert all of the fuel that is fed into the inlet of the fuel cells. In one embodiment, the anode exhaust stream 20 comprises carbon monoxide (CO), carbon dioxide (CO₂), hydrogen (H₂), unutilized fuel and water. In accordance with the present technique illustrated in FIG. 1, anode exhaust stream 20 is fed into heat exchanger 14 with isolated flow paths, wherein the hot anode exhaust stream 20 is cooled by transfer of the heat energy from the anode exhaust stream 20 to the incoming fuel stream 12. The cooled anode exhaust stream 22 exiting the heat exchanger 14 is fed into a separation unit 24, which separates carbon dioxide from the cooled anode exhaust stream 22 and produces a carbon dioxide rich stream 26, a hydrogen rich steam 28, a water stream 30 and a recycle stream 32 which can be recycled to the fuel inlet stream 10. The recycle stream 32 is mixed with the incoming fuel stream 10 and the mixed stream 12 is fed into the heat exchanger 14.

In an exemplary embodiment of the co-production system, the fuel cell assembly can be operated efficiently using a fuel supply such as natural gas with significant internal reforming as the fuel cell cooling is enhanced by the endothermic internal reforming. This internal reforming process converts natural gas to CO and H₂ as shown in reaction (1) prior to electrochemical consumption of H₂ and CO in the fuel cells. The fuel cell performance is enhanced by both high hydrogen fuel consumption in the fuel cell (hereinafter called utilization) and high cell operating voltages.

As will be appreciated by those skilled in the art, the reversible open circuit voltage (herein after OCV) of a hydrogen fuel cell is 1.23 volts at room temperature and standard pressure of 0.1 Mpa. At high temperatures in the range of about 600 to about 1000° C., the OCV is approximately between 0.9 to 1.1 volts depending on the hydrogen content of the fuel, oxygen content of the oxidant and the pressure and temperature of the fuel cell assembly. The typical relationship observed between the utilization and operating voltage of a fuel cell is that as the utilization increases the operating voltage drops gradually until a certain utilization value is reached. Beyond this utilization value, there is a rapid drop in the operating voltage with a small increase in utilization. In general, a given fuel cell operating on high voltages will not exhibit high fuel utilization, while a cell, which operates on high utilization will not exhibit high operating voltages at reasonable power densities. If both of these conditions are achieved, the fuel cell will, in general, operate on very low power densities, essentially increasing the number of cells required to produce a given power output and increasing the cost of the fuel cells. In accordance with the present techniques, the ability of the fuel cells to produce H₂ by internally reforming a fuel, such as natural gas, it is used to produce H₂, while separating the CO₂ from the anode exhaust stream. Co-production of both electricity and hydrogen with high overall thermal efficiencies further enhances the utility of a fuel cell system. Still further enhancement to the overall system efficiency is achieved by eliminating combustion of the fuel cell exhaust, this step being eliminated by separation techniques used for recovering the valuable fuel components from the anode exhaust stream.

Typically, the fuel cell anode exhaust is of low calorific value for a high utilization fuel cell and it is difficult to combust this fuel in a conventional manner. This problem is also eliminated by the low utilization internal reforming fuel cell, as the anode exhaust is further processed to extract hydrogen rather than to produce power. In accordance with the present technique as shown in FIG. 1, in one mode the fuel cell assembly 18 is operated in a low utilization mode wherein the hydrogen fuel is consumed between approximately 30% and approximately 70% of the total fuel available for reaction. In this mode of operation the operating voltage of the fuel cell assembly 18 is maintained between approximately 0.7 volts and approximately 0.85 volts. In another mode of operation, the fuel cell assembly 18 is operated at a voltage, which may be substantially below the reversible operating voltage of the fuel cell of 1.0 volt at high temperatures and pressures. The operating voltage for this mode may vary between approximately 0.5 volts and approximately 0.7 volts. This mode of operation results in a relatively high utilization of about 80% to about 90% with reasonable current density.

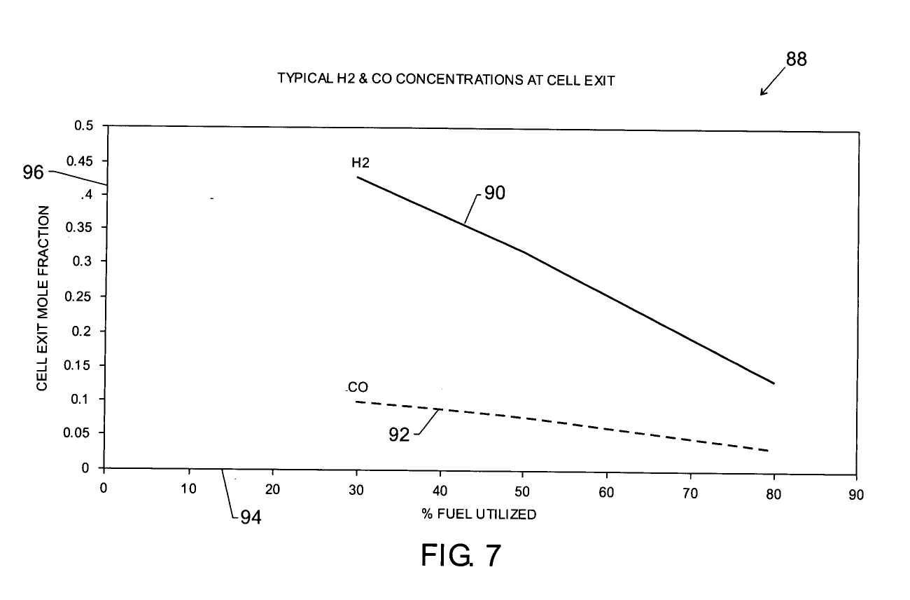

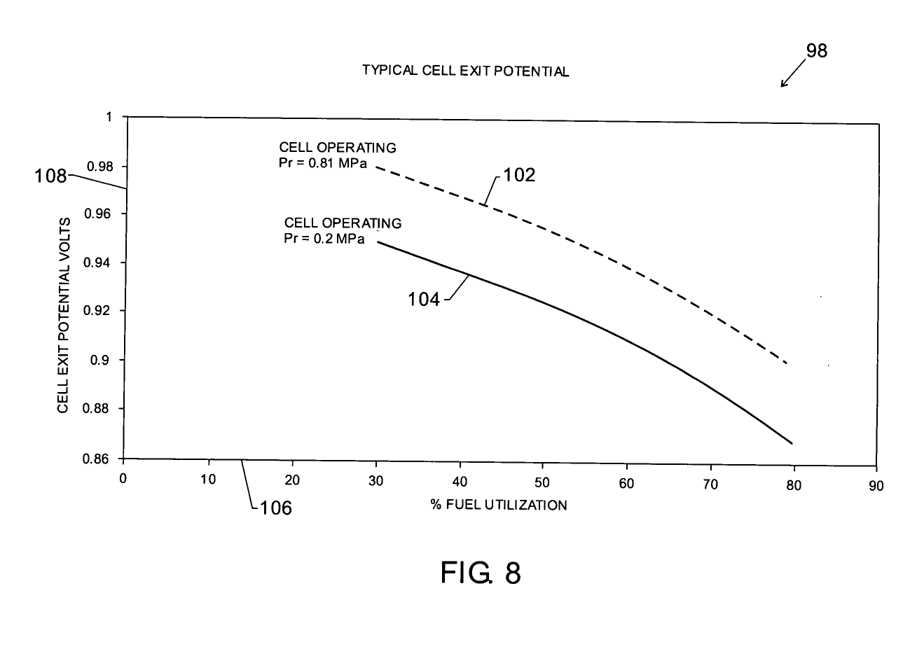

The process, when the fuel cell is operated at a low utilization mode, uses controlled fuel cells with very high fuel flow rate relative to the power generated by the fuel cells. The fuel is internally reformed in the fuel cell by the endothermic reforming reaction producing H₂ and CO, among other components as described earlier. Because the available electrochemical potential in a fuel cell is a function of the fuel composition at various locations of the cell, the hydrogen rich fuel at the exit of the cell enables very high electrochemical potential. Consequently, the cell can be operated at higher voltages and still produce significantly high current and high power densities. In the low utilization mode, the mole fraction of H₂ at the outlet of the fuel cell may be in the range of about 0.1 to about 0.5, and the mole fraction of CO at the outlet of the fuel cell may be about 0.05 to about 0.15. Typical fuel cell exit compositions of H₂ and CO are illustrated in FIG. 7 as a function of the % fuel utilization in the fuel cell. The X axis 94 is the % fuel utilization in the fuel cell and the Y axis 96 is the mole fraction at cell exit. The mole fraction of H₂ as a function of % fuel utilization is shown by the path 90, and the mole fraction of CO as a function of % fuel utilization is shown by the path 92. The fuel cell exit potentials are illustrated in FIG. 8 as a function of % fuel utilization. The X axis 106 is the % fuel utilization in the fuel cell and the Y axis 108 is the potential at the fuel cell exit. The potential at the fuel cell exit at a pressure of 0.81 Mpa as a function of the % fuel utilization is shown by the path 102, and the fuel cell exit potential at a pressure of 0.2 MPa as a function of the % fuel utilization is shown by the path 104. These graphs (FIG. 7 and FIG. 8) are obtained for fuel cells using natural gas as an incoming fuel with high degree of internal reforming of natural gas with water.

The low utilization mode, which as mentioned above, operates at a relatively high operating voltage, can also be described as an enhanced hydrogen production mode. In this mode, because a relatively low percent of fuel is utilized in the fuel cells as described above, a substantial quantity of hydrogen remains in the anode exhaust stream 20. Returning to FIG. 1, the anode exhaust stream 20 from the cell comprises H₂, CO, CO₂, water and unreacted fuel. The anode exhaust stream 20 at the exit of the fuel cell assembly can be cooled to a temperature of about 200 to about 400° C. using the heat exchanger 14.

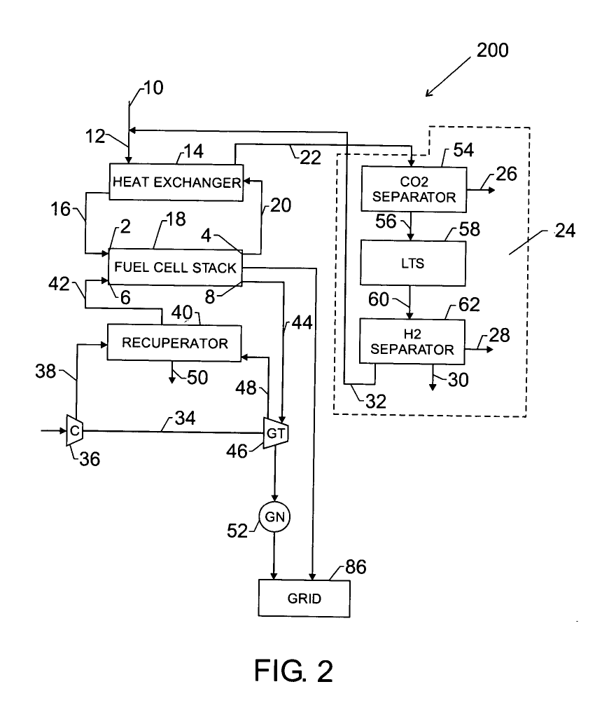

Various exemplary embodiments of the co-production system are illustrated in FIGS. 2, 3 and 4 using different schemes for the separation unit 24. All exemplary embodiments, as illustrated in FIGS. 2, 3 and 4 share the basic components of the co-production system 100 (shown in FIG. 1), in which like features are designated with like reference numerals.

A second exemplary embodiment of the co-production system 200 is illustrated in FIG. 2. In accordance with the second embodiment, the separation unit 24 comprises a carbon dioxide separator 54, a low temperature shift (LTS) reactor 58 and a hydrogen separator 62.

The anode exhaust stream 20 is typically at a high temperature of about 600 C to about 800 C. The anode exhaust stream 20 is fed into the heat exchanger 14 to utilize the high level of heat content, thereby heating the incoming fuel stream 12. The cooled anode exhaust stream 22 is fed into the carbon dioxide separator 54. The carbon dioxide separator 54 may apply various techniques known in the art, including but not limited to pressure swing adsorption, chemical absorption and membrane separation.

Pressure swing adsorption (PSA) may be used for separation of carbon dioxide from a mixture of gases containing hydrogen. In PSA techniques, at a high partial pressure, solid molecular sieves can adsorb carbon dioxide more strongly than hydrogen. As a result, at elevated pressures, carbon dioxide is removed from the mixture of gases comprising hydrogen when this mixture is passed through an adsorption bed. Regeneration of the bed is accomplished by depressurization and purging. Typically for critical operations, a plurality of adsorption vessels is used for continuous separation of carbon dioxide, wherein one adsorption bed is used while the others are regenerated.

Another technique for separation of carbon dioxide from a gas stream is chemical absorption using oxides, such as, calcium oxide (CaO) and magnesium oxide (MgO) or a combination thereof. In one embodiment, at elevated pressure and temperature, CO₂ is absorbed by CaO forming calcium carbonate (CaCO₃), thereby removing CO₂ from the gas mixture. The sorbent CaO is regenerated by calcinations of CaCO₃, which can again reform CaCO₃ to CaO.

Membrane separation technology may also be used for separation of carbon dioxide from a gas stream. Membrane processes are generally more energy efficient and easier to operate than absorption processes. The membranes used for high temperature carbon dioxide separation include zeolite and ceramic membranes, which are selective to CO₂. However, the separation efficiency of membrane technologies is low, and complete separation of carbon dioxide may not be achieved through membrane separation. Typically membrane separators work more efficiently at higher pressures, and use of a membrane separator to separate the carbon dioxide from the anode exhaust stream 22, it may be desirable to further compress the anode exhaust stream 22 prior to separation of CO₂.

In some embodiments, the carbon dioxide separator 54 may comprise at least one adsorption bed where a PSA technique is used to separate the carbon dioxide from the cooled anode exhaust steam 22. In some other embodiments, the carbon dioxide separator 54 may comprise at least one absorption vessel, where a chemical absorption technique is used. In yet another embodiment the carbon dioxide separator 54 comprises at least one membrane separator. Using the various techniques described herein, a carbon dioxide rich stream 26 and a carbon dioxide lean stream 56 are generated from the carbon dioxide separator 54. The carbon dioxide rich stream 26 may be exported for any other industrial use.

The carbon dioxide lean stream 56 comprises hydrogen, un-separated carbon dioxide, carbon monoxide, unreacted fuel and water. The carbon monoxide and water in the stream 56 may react further to produce carbon dioxide. This may be achieved through exothermic reaction (2), known as a water gas shift reaction. The CO₂ lean stream 56 is fed into a low temperature shift (LTS) reactor 58 to facilitate the water gas shift reaction in presence of a catalyst. The exit stream from the water gas shift reactor 58 comprises unreacted fuel, carbon dioxide, and traces of unconverted carbon monoxide, water and hydrogen.

The exit stream 60 from the LTS reactor 58 is fed into a hydrogen separator 62. The methods to separate hydrogen from stream 60 to produce a substantially pure hydrogen stream 28 include PSA and membrane separation. A variety of polymers may be used for hydrogen selective membranes, which operate at relatively low temperatures. In one embodiment, the separation efficiency of the hydrogen can be enhanced by combining a PSA unit with CO₂ separation membranes. In the first step H₂ is separated by a PSA technique. In the next step, CO₂ is separated by CO₂ selective membranes. Some polymeric membranes show good permselectivity for CO₂ separation at relatively low temperature.

In some embodiments, the hydrogen separator 62 may use a cryogenic separation technique. Cryogenic separation may be used when it is important to recover multiple fractionates and multiple products. In one embodiment, the exit stream 60 from the LTS reactor 58 is compressed to approximately 900 psia and then cooled to room temperature using a condenser, which liquefies the CO₂. Hydrogen can be recovered as a gas from this process, while the CO₂ is removed as liquid from the bottom of the condenser.

The hydrogen separator 62 may further be integrated with a moisture separator from which a water rich stream 30 is obtained.

In one embodiment, the moisture separator (not shown) may be a mechanical device, such as a centrifuge to separate water. In some other embodiments, the moisture separator is a condenser or a chiller to condense the water present in the stream 60. In yet another embodiment, the moisture can be separated using at least one molecular sieve bed, which absorbs moisture. The recycle stream 32 from the hydrogen separator 62 comprises unreacted fuel, un-separated hydrogen and water. In some embodiments it may further comprise traces of carbon dioxide and carbon monoxide. The stream 32 is recycled to the inlet of the heat exchanger 14 along with incoming fuel stream 10.

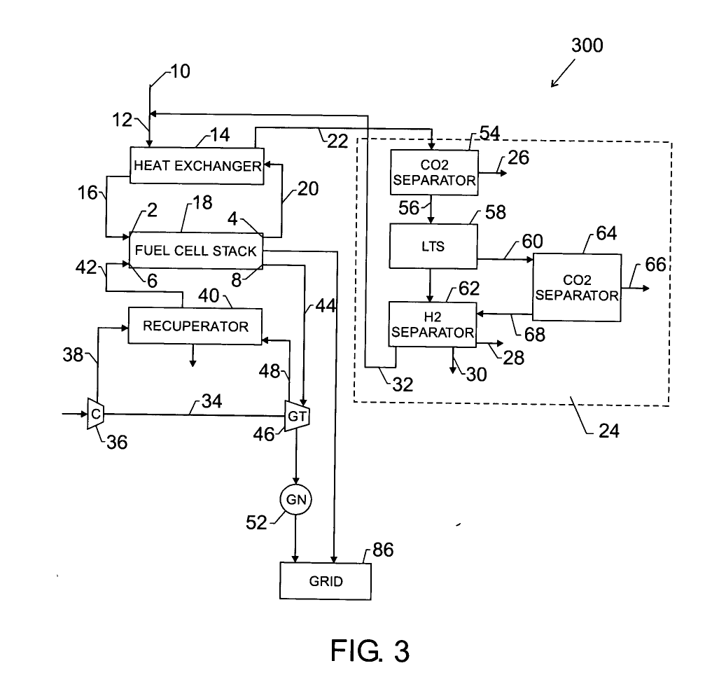

The third exemplary embodiment of the co-production system 300 is illustrated in FIG. 3 in accordance with the third exemplary embodiment, the separation unit 24 comprises two carbon dioxide separators 54 and 64. Carbon dioxide separator 54 separates carbon dioxide from the cooled anode exhaust stream 22 at a relatively high temperature using the techniques discussed in the previous sections. Two streams are recovered from the carbon dioxide separator 54, a CO₂ rich stream 26 and a CO₂ lean stream 56. The CO₂ lean stream 56 is fed into the LTS reactor 58 for facilitating the water gas shift reaction as described as reaction (2) above. The exit stream 60 from the LTS reactor 58 is fed into an additional carbon dioxide separator 64. The additional carbon dioxide separator 64 is used to separate the CO₂ formed in the low temperature shift (LTS) reactor 58.

The technique used for separation of CO₂ from the stream 60 may include, but not limited to chemical absorption of CO₂ using amines. The inlet stream 60 to the additional carbon dioxide separator 64 may be cooled to a suitable temperature to use chemical absorption of carbon dioxide using amines. This technique is based on alkanol amines solvents that have the ability to absorb carbon dioxide at relatively low temperatures, and are easily regenerated by raising the temperature of the rich solvents. A carbon dioxide rich stream 66 is obtained after regeneration of the rich solvent. The solvents used in this technique may include triethanolamine, monoethanolamine, diethanolamine, diisopropanolamine, diglycolamine, and methyldiethanolamine. Any other techniques of separating carbon dioxide as described in the preceding sections may also be applicable. A CO₂ lean stream 68 is recovered from the carbon dioxide separator 64 and is fed into a hydrogen separator 62. Techniques for hydrogen separation may include those discussed above. In one embodiment, the hydrogen separator 62 may be integrated with a moisture separator to separate the water present in the CO₂ lean stream 62. Three streams are recovered from the hydrogen and integrated moisture separator, a substantially pure hydrogen stream 28 to be exported for other industrial use, a water stream 30 and a recycle stream 32. The recycle stream 32 from the hydrogen separator 62 comprises unreacted fuel, un-separated hydrogen and water. In some embodiments it may further comprise traces of carbon dioxide and carbon monoxide. The stream 32 is recycled back to the inlet of the heat exchanger 14 along with incoming fuel stream 10.

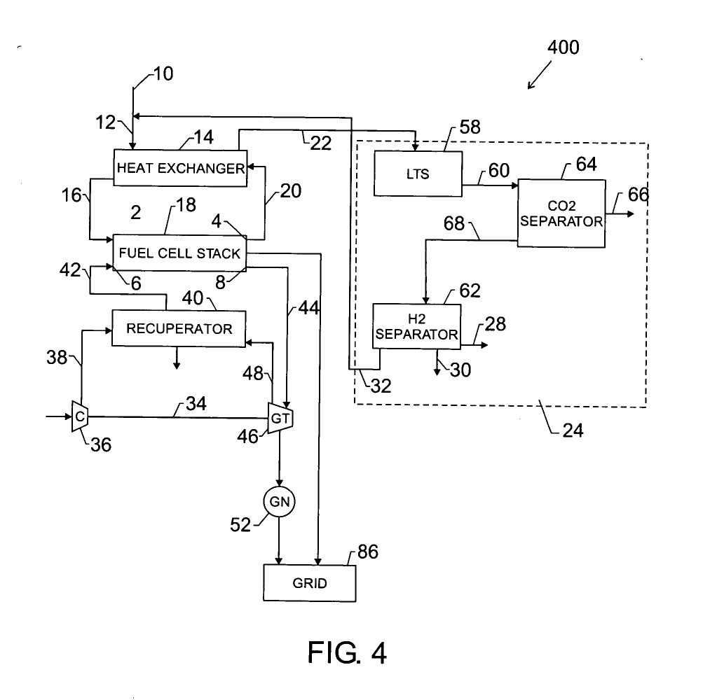

A fourth exemplary embodiment of the co-production system 400 is illustrated in FIG. 4 in accordance with the fourth exemplary embodiment, the separation unit 24 comprises a LTS reactor 58, a carbon dioxide separator 64 and a hydrogen separator 62. The cooled anode exhaust stream 22 is fed directly to the LTS reactor 58, where the water gas shift reaction (1) takes place. The exit stream 60 from the LTS reactor 58 comprises carbon dioxide, hydrogen, water, unreacted fuel and traces of carbon monoxide. Stream 60 is fed into the carbon dioxide separator 66 from where a carbon dioxide rich stream 66 is obtained. The techniques used in separating carbon dioxide from stream 60 may include those discussed above. The exit stream 68 from the carbon dioxide separator 66 is fed into the hydrogen separator 62 and a hydrogen rich stream 28 is obtained from the hydrogen separator 62.

In one embodiment, the hydrogen separator 62 may be integrated with a moisture separator to separate the water present in the CO₂ lean stream 62. Three streams are recovered from the hydrogen and integrated moisture separator, a substantially pure hydrogen stream 28 to be exported for other industrial use, a water stream 30 and a recycle stream 32. The recycle stream 32 from the hydrogen separator 62 comprises unreacted fuel, un-separated hydrogen and water. In some embodiments it may further comprise traces of carbon dioxide and carbon monoxide. The stream 32 is recycled to the inlet of the heat exchanger 14 along with incoming fuel stream 10.

Returning to FIG. 1, the hot cathode exhaust 44 is fed into the working fluid paths of gas turbine 46. Thermodynamic expansion of the exhaust 44 produces power to drive the turbine 46, which, in turn, generates electricity in generator 52. Electricity from generator 52 and fuel cell assembly 18 are converted to an appropriate form provided to a distribution power supply network grid 86.

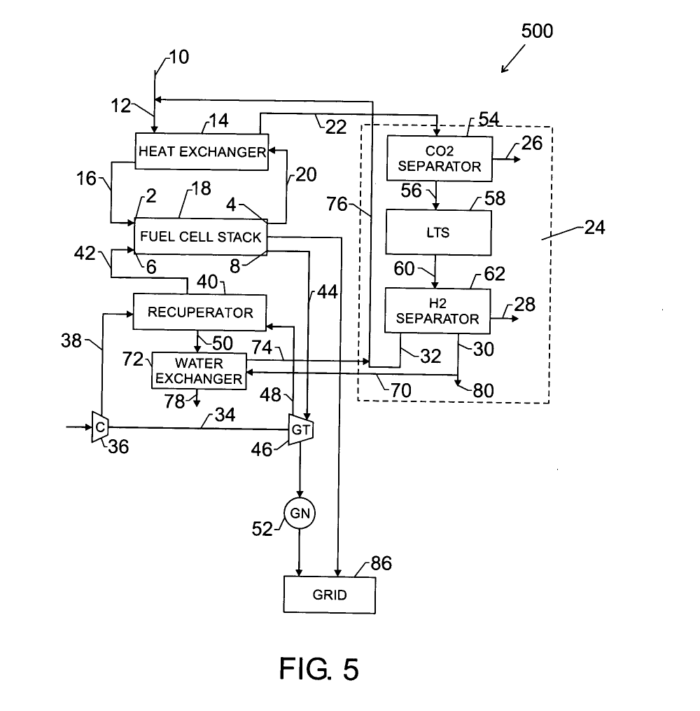

A fifth exemplary embodiment of the co-production system 500 is illustrated in FIG. 5 sharing the basic components of the co-production system 200 (shown in FIG. 2), in which like features are designated with like reference numerals.

In the gas turbine portion of the co-production system 500, compressor 36 supplies compressed air to recuperator 40, and the compressed air within recuperator 40 is heated by the turbine exhaust 48 as described above to produce a heated air stream supply 42 to cathode inlet 6. In fuel cell assembly 18, air is reacted with a fuel to generate electricity as described above.

Gaseous fuel 10, which in different embodiments may be natural gas, methane or a coal derived fuel gas, for example, is fed into heat exchanger 14, which is a known type of heat exchanger including isolated flow paths. The fuel stream may be driven by fuel pump (not shown) through a de-sulfurizer (not shown), which in an exemplary embodiment includes a vessel containing a bed of sulfur sorbent through which fuel flows. Heat from fuel cell anode exhaust 20 is transferred to the incoming fuel stream 12 to warm the fuel therein before being fed into the fuel cell assembly 18. As noted above, the fuel cell assembly 18 may be operated in different modes, for example, low utilization mode as discussed above.

In accordance with the fifth embodiment as illustrated in FIG. 5, the anode exhaust stream 20 is fed into the heat exchanger 14 to utilize the high level of heat content in the anode exhaust stream to heat the incoming fuel stream 12. The relatively cooler anode exhaust stream 22 is fed into the carbon dioxide separator 54. The carbon dioxide separator 54 may involve various techniques discussed above, including but not limited to pressure swing adsorption, chemical absorption and membrane separation.

Using one or more techniques described above, a carbon dioxide rich stream 26 and a carbon dioxide lean stream 56 are generated from the carbon dioxide separator 54. The carbon dioxide rich stream 26 may be exported for any other industrial use.

The carbon dioxide lean stream 56 comprises hydrogen, un-separated carbon dioxide, carbon monoxide, unreacted fuel and water. The carbon monoxide and water in the stream 56 may react further to produce carbon dioxide. This may be achieved through the exothermic reaction (2) described above. Also as described above, the water gas shift reaction takes place in the low temperature shift (LTS) reactor 58. The exit stream 60 from the water gas shift reactor 58 contains some unreacted fuel, carbon dioxide, traces of unconverted carbon monoxide, water and hydrogen.

The exit stream 60 from the LTS reactor 58 is fed into a hydrogen separator 62. The methods to separate hydrogen from the stream 60 to produce a substantially pure hydrogen stream 28 are described in the preceding sections.

The hydrogen separator 62 may further be integrated with a moisture separator from which a water rich stream 30 is obtained. The devices and methods to separate the moisture are described in the preceding sections. The recycle stream 32 from the hydrogen separator 62 comprises unreacted fuel, un-separated hydrogen and water. In some embodiments it may further comprise traces of carbon dioxide and carbon monoxide. The stream 32 is recycled back to the inlet of the heat exchanger 14 along with incoming fuel stream 10.

A portion of the water stream 30 is sent to a water exchanger 72 wherein the water is heated up using the heat content of the spent air 50 exiting from the recuperator 40. The heated water stream 74 is mixed with the recycle stream 32 from the hydrogen separator 62 and the mixed stream 76 is recycled back to the inlet of the fuel stream 10. The water recycled through stream 74 provides the steam for the internal reforming of the incoming fuel inside the fuel cell assembly 18 and further utilizes the heat content of the spent air stream 50 from the recuperator 40. The cooled spent air stream 78 may be discharged into the atmosphere from the water exchanger 72.

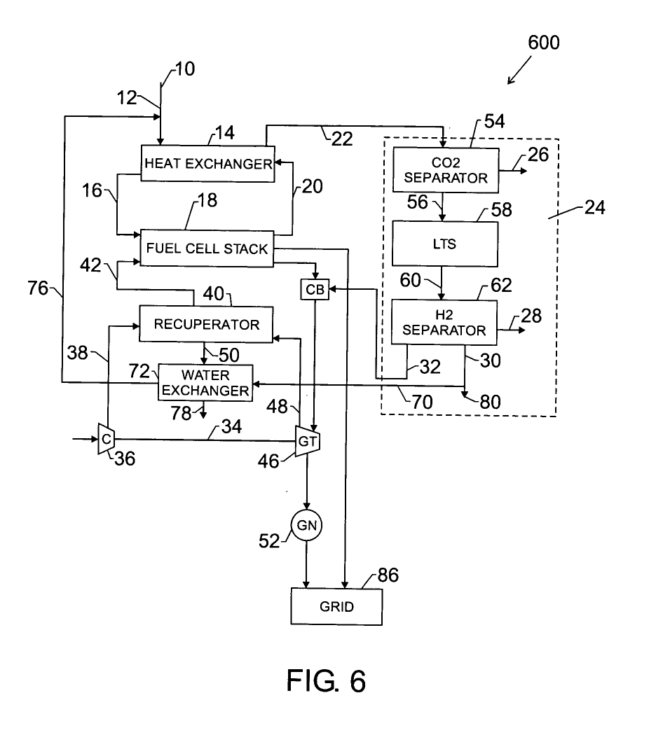

A sixth exemplary embodiment of the co-production system 600 is illustrated in FIG. 6 sharing the basic components of the co-production system 200 (shown in FIG. 2), in which like features are designated with like reference numerals.

In accordance with the sixth embodiment as shown in FIG. 6, a portion of the water stream 30 is sent to a water exchanger 72 wherein the water is heated using the heat content of the spent air 50 exiting from the recuperator 40. The heated water stream 74 is sent directly to the inlet fuel stream 10 to provide steam for the internal reforming inside the fuel assembly 18. Recycle stream 32 from the hydrogen separator 62 is sent to a catalytic combustor or a catalytic burner 82. The stream 32 comprises carbon monoxide and some amount of unreacted fuel. In order to recover energy from all fuel in the co-production system 600, in this embodiment, the recycle stream 32 is sent to a catalytic burner 82 where the recycle stream is mixed with the exhaust air stream 44 from cathode outlet 8. In the catalytic burner 82, the recycle stream 32 is combusted with the spent air stream 44 in presence of a catalyst to produce a hot gas stream 84. The hot gas stream 84 from the catalytic burner 82 is fed into the working fluid paths of gas turbine 46. Thermodynamic expansion of the exhaust 84 produces power to drive the turbine 14, which, in turn, generates electricity in generator 52. As discussed above, electricity from generator 52 and fuel cell assembly 18 is converted to an appropriate form provided to a distribution power supply network, illustrated as grid 86 in FIG. 6.

The co-production systems in accordance with the various embodiments discussed above have the flexibility to control the production of hydrogen from the anode exhaust stream and generation of electricity depending on the demand. For higher demand of exported hydrogen, the fuel call assembly is operated on low utilization mode wherein the anode exhaust stream comprises higher amount of unutilized hydrogen, which may be recovered for export using the separation unit downstream of the fuel cell assembly.

Producing hydrogen for external use by internally reforming the incoming fuels in the fuel cell assembly maximizes the benefits of the disclosed co-production systems. The hydrogen stream separated from the anode exhaust stream may be stored and transported either in gaseous form or in liquid form, such as by means of a liquefaction plant. The carbon dioxide stream obtained from the separation process of the anode exhaust stream may also be used in any suitable application. The separation of carbon dioxide and the conversion of carbon dioxide to carbon monoxide in all the embodiments described above reduce the emission of carbon monoxide in the environment.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system for co-production of hydrogen and electrical energy comprising:
a fuel cell assembly comprising a plurality of fuel cells, the fuel cells further comprising a cathode inlet for receiving a compressed oxidant, an anode inlet for receiving a fuel feed stream, an anode outlet in fluid communication with an anode exhaust stream and a cathode outlet in fluid communication with a cathode exhaust stream; wherein at least a portion of the fuel feed stream reacts with the oxidant to produce electrical power and the anode exhaust stream comprises hydrogen; and
a separation unit in fluid communication with the fuel cell assembly, wherein the separation unit is configured to receive the anode exhaust stream from the fuel cell assembly to separate hydrogen from the anode exhaust stream.

2. The system according to claim 1, wherein the fuel cell assembly is operated in a low utilization mode, in which the fuel feed stream is consumed at a rate less than or equal to 70%.

3. The system according to claim 1, wherein the fuel cell assembly is operated in an enhanced hydrogen production mode.

4. The system according to claim 1, wherein the fuel cell assembly is operated at a voltage of about 0.7 volts to about 0.85 volts.

5. The system according to claim 1, wherein the mole fraction of hydrogen at the anode outlet is between about 0.1 to about 0.5

6. The system according to claim 1, wherein the oxidant is air.

7. The system according to claim 1, wherein the fuel feed stream comprises at least one fuel selected from the group consisting of natural gas, methane, and a coal derived gas.

8. The system according to claim 1 further comprising a heat exchanger configured to receive and heat the fuel feed stream using the anode exhaust stream from the fuel cell assembly.

9. The system according to claim 1, wherein the fuel cell is selected from the group consisting of solid oxide fuel cells, molten carbonate fuel cells, regenerative fuel cells, and protonic ceramic fuel cells.

10. The system according to claim 9, wherein the fuel cell is a solid oxide fuel cell.

11. The system according to claim 1, wherein at least a portion of the anode exhaust stream is recycled back to the anode inlet after separation of hydrogen.

12. The system according to claim 1, wherein the anode exhaust stream further comprises carbon monoxide, carbon dioxide, unreacted fuel and water.

13. The system according to claim 12, wherein the separation unit comprises a carbon dioxide separator to separate carbon dioxide from the anode exhaust stream.

14. The system according to claim 13, wherein the carbon dioxide separator is selected from the group consisting of at least one chemical absorber, pressure swing adsorber, cryogenic separator, membrane separator and carbon dioxide liquefier.

15. The system according to claim 12, wherein the separation unit further comprises a low temperature shift reactor for converting carbon monoxide to carbon dioxide and a hydrogen separator.

16. The system according to claim 15, wherein the carbon dioxide is separated from the anode exhaust stream in at least one location selected from the group consisting of a location prior to the low temperature shift reactor, a location after the low temperature shift reactor and a combination thereof.

17. The system according to claim 15, wherein the hydrogen separator comprises at least one membrane.

18. The system according to claim 12, wherein the separation unit further comprises a moisture separator to separate water from the anode exhaust stream.

19. The system according to claim 18, wherein the moisture separator is selected from the group consisting of at least one condenser, molecular sieve bed and chiller.

20. A system for co-production of hydrogen and electrical energy comprising:
a fuel cell assembly comprising a plurality of fuel cells, the fuel cells further comprising a cathode inlet for receiving a compressed oxidant, an anode inlet for receiving a fuel feed stream, an anode outlet in fluid communication with an anode exhaust stream and a cathode outlet in fluid communication with a cathode exhaust stream; wherein at least a portion of the fuel feed stream reacts with the oxidant to produce electrical power and the anode exhaust stream comprises hydrogen; and
a separation unit in fluid communication with the fuel cell assembly, wherein the separation unit is configured to receive the anode exhaust stream from the fuel cell assembly to separate hydrogen from the anode exhaust stream;
wherein the fuel cell assembly is operated at a low utilization mode, in which the fuel feed stream is consumed at a rate less than or equal to 70%.

21. The system according to claim 20, wherein the oxidant is air.

22. The system according to claim 20, wherein the fuel cell assembly is operated at a voltage of about 0.7 volts to about 0.85 volts.

23. The system according to claim 20, wherein the mole fraction of hydrogen at the anode outlet is between about 0.1 to about 0.5.

24. The system according to claim 20, wherein the fuel cell is selected from the group consisting of solid oxide fuel cells, molten carbonate fuel cells, regenerative fuel cells, and protonic ceramic fuel cells.

25. The system according to claim 24, wherein the fuel cell is a solid oxide fuel cell.

26. The system according to claim 20, further comprising a heat exchanger configured to receive and heat the fuel feed stream using the anode exhaust stream from the fuel cell assembly.

27. The system according to claim 20, wherein the anode exhaust stream further comprises carbon monoxide, carbon dioxide, unreacted fuel and water.

28. The system according to claim 27, wherein the separation unit comprises a carbon dioxide separator to separate carbon dioxide from the anode exhaust stream.

29. The system according to claim 28, wherein the separation unit further comprises a low temperature shift reactor for converting carbon monoxide to carbon dioxide and a hydrogen separator.

30. The system according to claim 27, wherein the separation unit further comprises a moisture separator to separate water from the anode exhaust stream.

31. A system for co-production of hydrogen and electrical energy comprising:
a fuel cell assembly comprising a plurality of fuel cells, the fuel cells further comprising a cathode inlet for receiving a compressed oxidant, an anode inlet for receiving a fuel feed stream, an anode outlet in fluid communication with an anode exhaust stream and a cathode outlet in fluid communication with a cathode exhaust stream; wherein at least a portion of the fuel feed stream reacts with the oxidant to produce electrical power and the anode exhaust stream comprises hydrogen; and
a separation unit in fluid communication with the fuel cell assembly, wherein the separation unit is configured to receive the anode exhaust stream from the fuel cell assembly to separate hydrogen from the anode exhaust stream;
wherein the fuel cell is operated at a low utilization mode in which the output voltage from the fuel cell assembly is maintained substantially below 1.0 volt.

32. The system according to claim 31, wherein the fuel cell is selected from the group consisting of solid oxide fuel cells, molten carbonate fuel cells, regenerative fuel cells, and protonic ceramic fuel cells.

33. The system according to claim 32, wherein the fuel cell is a solid oxide fuel cell.

34. The system according to claim 31, wherein the fuel cell assembly is operated at a voltage of about 0.5 volts to about 0.7 volts.

35. A system for co-production of hydrogen and electrical energy comprising:
a solid oxide fuel cell assembly comprising a plurality of solid oxide fuel cells, the solid oxide fuel cells further comprising a cathode inlet for receiving a compressed air, an anode inlet for receiving a fuel feed stream, an anode outlet in fluid communication with an anode exhaust stream and a cathode outlet in fluid communication with a cathode exhaust stream; wherein at least a portion of the fuel feed stream reacts with the oxidant to produce electrical power and the anode exhaust stream comprises hydrogen; and
a separation unit in fluid communication with the solid oxide fuel cell assembly, wherein the separation unit is configured to receive the anode exhaust stream from the solid oxide fuel cell assembly to separate the hydrogen from the anode exhaust stream;
wherein the fuel cell is operated at a low utilization mode in which the output voltage is maintained substantially below 1.0 volt.

36. A method for co-production of hydrogen and electrical energy comprising:
introducing a fuel feed stream into a fuel cell assembly comprising a plurality of fuel cells;
operating the fuel cell assembly in a low utilization mode to produce electrical energy and producing an anode exhaust stream comprising hydrogen;
introducing the anode exhaust stream into a hydrogen separation unit; and
recovering a substantially pure hydrogen stream from the hydrogen separation unit.

37. The method according to claim 36 further comprising recycling at least a portion of the anode exhaust stream into the anode inlet after the separation of hydrogen.

38. The method according to claim 36, wherein the fuel cell is selected from the group consisting of solid oxide fuel cells, molten carbonate fuel cells, regenerative fuel cells, and protonic ceramic fuel cells.

39. The method according to claim 38 wherein the fuel cell is a solid oxide fuel cell.

40. A method for producing hydrogen from an anode exhaust stream from a solid oxide fuel cell assembly comprising a plurality of solid oxide fuel cells, the method comprising:
introducing the anode exhaust stream from the solid oxide fuel cell assembly to a carbon dioxide separator;
recovering two streams, a carbon dioxide rich stream and a carbon dioxide lean stream from the carbon dioxide separator;
introducing the carbon dioxide lean stream to a low temperature shift reactor and recovering a hydrogen rich stream; and
introducing the hydrogen rich stream to a hydrogen separator and recovering a substantially pure hydrogen stream from the hydrogen separator;
wherein the anode exhaust stream from the solid oxide fuel cell assembly comprises hydrogen, carbon dioxide, carbon monoxide and water.

41. The method according to claim 40 further comprising separating water from the anode exhaust stream.
